(19) United States
(12) Patent Application Publication
(10) Pub. No.: US 2011/0061489 A1
(43) Pub. Date: Mar. 17, 2011

(54) ROTARY CONTROL KNOB APPARATUS

(75) Inventors: David S. Bulin, Greentown, IN (US); Mark A. Gill, Russiaville, IN (US); David J. Clute, Cicero, IN (US); Steven V. Netherton, Tipton, IN (US)

(73) Assignee: DELPHI TECHNOLOGIES, INC., Troy, MI (US)

(21) Appl. No.: 12/558,709

(22) Filed: Sep. 14, 2009

(51) Int. Cl. G05G 1/10

(52) U.S. Cl. 74/553

(57) ABSTRACT

A rotary control knob apparatus includes a stationary knob retainer having a cylindrical post and an annular knob that slides over the retainer post, where the exterior periphery of the retainer post has a distributed array of compliant protrusions that contact the inner periphery of the knob to provide a resilient sliding interference fit between the knob and the retainer post. In a preferred arrangement, the retainer is secured against the rear surface of a control panel trimplate, and the knob is axially captured between the trimplate and a retainer flange extending radially outward from the base of the cylindrical post.

### TECHNICAL FIELD

The present invention relates to rotary control knobs for automotive and consumer electronics applications, and more particularly to an improved rotary control knob apparatus that minimizes axial tilting of the knob.

### BACKGROUND OF THE INVENTION

Rotary knobs are commonly used in connection with automotive or consumer electronic products such as radios for user-adjustment of control parameters such as volume and tuning. A typical knob assembly comprises several mechanically coupled parts, and tolerance variations in the manufacture of the constituent parts can result in tolerance stack-up that allows the knob to axially tilt, or wobble, with respect to its mounting surface. Since this tilting or wobbling is aesthetically unpleasing, and can reflect unfavorably on the quality of the product, what is needed is a rotary control knob assembly in which the axial orientation of the knob is tightly controlled even though the parts of the assembly are subject to the usual manufacturing tolerance variations.

### SUMMARY OF THE INVENTION

The present invention provides an improved rotary control knob apparatus including a stationary knob retainer having a cylindrical post and an annular knob that slides over the retainer post, where the exterior periphery of the retainer post has a distributed array of compliant protrusions that contact the inner periphery of the knob to provide a resilient sliding interference fit between the knob and the retainer post. In a preferred arrangement, the retainer is secured against the rear surface of a control panel trimplate, and the knob is axially captured between the trimplate and a retainer flange extending radially outward from the base of the cylindrical post.

### BRIEF DESCRIPTION OF THE DRAWINGS

FIG. 1 is an exploded isometric view of a rotary control knob apparatus according to this invention.

FIG. 2 is an assembled isometric view of the rotary control knob apparatus of FIG. 1.

FIG. 3 is an enlarged isometric view of a knob retainer element illustrated in FIG. 1.

FIG. 4 is an isometric cross-sectional view of the rotary control knob apparatus of FIG. 2, minus the circuit board and push-button actuator of FIG. 2.

### DESCRIPTION OF THE PREFERRED EMBODIMENT

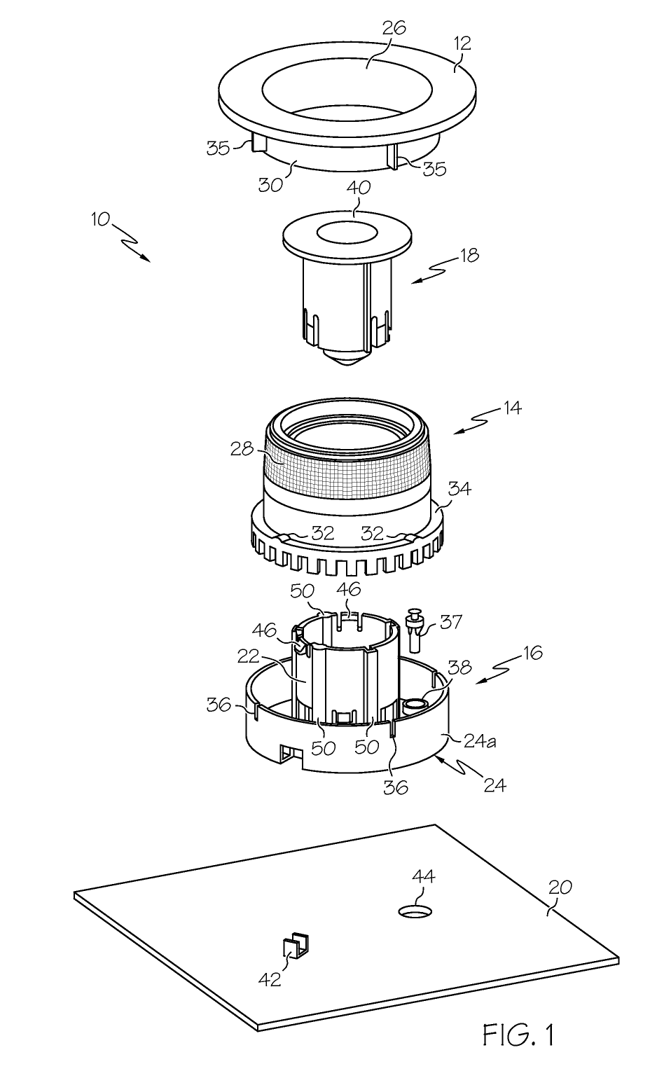

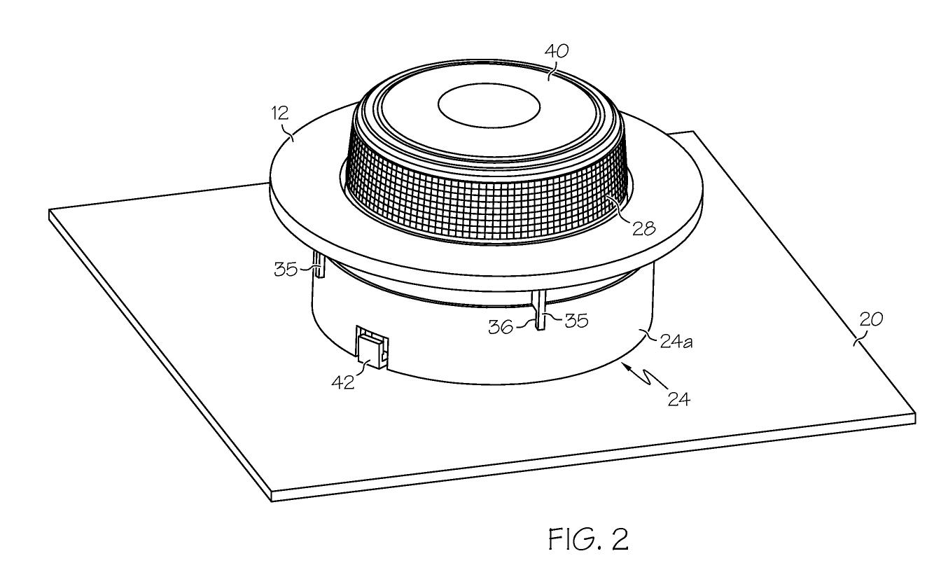

Referring to the drawings, and particularly to FIGS. 1-2, the reference numeral 10 generally designates a rotary control knob assembly mounted with respect to a trimplate 12 of an electronic product such as an automotive radio. The assembly 10 includes an annular control knob 14, a knob retainer 16, a push-button actuator 18, and a circuit board 20. The knob retainer 16 is preferably an injection-molded plastic part; it includes a hollow cylindrical post 22 and a cup-shaped flange 24 that extends radially outward from the base of the post 22. The push-button actuator 18 slides into the hollow retainer post 22, whereas the knob 14 slides over the retainer post 22 and is compliantly supported within the cup-shaped retainer flange 24. The trimplate 12 is provided with an opening 26 through which the grip portion 28 of knob 14 extends, and an inwardly depending cylindrical flange 30 that engages a set of radial ridges 32 formed on a toothed flange 34 of knob 14 to capture knob 14 between trimplate 12 and the cup-shaped retainer flange 24. A set of ribs 35 extending radially outward from the cylindrical flange 30 nest in complementary slots 36 formed in the rim 24a of retainer flange 24 to rotationally lock retainer 16 to trimplate 12. A spring-loaded plunger 37 disposed in a circular well 38 formed in the base of the cup-shaped retainer flange 24 slidingly engages a convoluted surface of knob 14 inboard of the toothed flange 34 to impart a detent effect as the knob 14 is rotated with respect to the knob retainer 16.

The circuit board 20 is fastened to the trimplate 12 so as to engage and axially capture the knob retainer 16 with respect to the trimplate 12. The circuit board 20 may additionally include lighting components (not shown) for backlighting graphics formed on the face 40 of push-button actuator 18, contacts (not shown) for interfacing with the push-button actuator 18, and a U-shaped optical sensor 42 with legs that straddle the toothed knob flange 34 to detect rotation of the knob 14. The circuit board 20 also includes an opening 44 for accommodating the circular well 38 of knob retainer 16.

As mentioned above, the principle objective of the present invention is to provide a rotary control knob assembly 10 in which the axial orientation of the knob 14 is tightly controlled even though the parts of the assembly 10 are subject to the usual manufacturing tolerance variations. This objective is achieved, according to this invention, by providing a resilient sliding interference fit between the knob 14 and the hollow cylindrical retainer post 22 on which the knob 14 is supported. In the illustrated embodiment, the interior periphery of the annular rotary knob 14 is smooth, and compliant features that provide the resilient sliding interference fit are formed on the exterior periphery of the hollow retainer post 22.

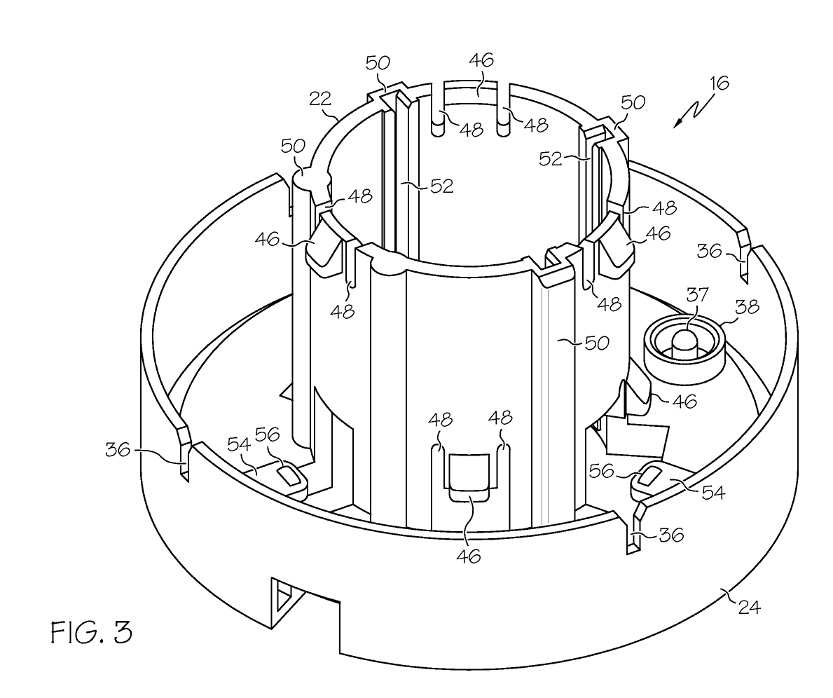

As best seen in FIG. 3, the compliant features on the exterior periphery of the retainer post 22 comprise a distributed array of protrusions 46 that extend radially outward to contact the smooth inner periphery of the annular knob 14. As seen in FIG. 3, the protrusions 46 are distributed around the circumference of the post 22, at both upper and lower ends of the post 22. In the illustrated arrangement, three protrusions 46 are distributed around the upper end of the post 22, and four protrusions 46 are distributed around the lower end of the post 22. The upper surfaces of the protrusions 46 are tapered as shown to facilitate assembly of the knob 14 onto the retainer post 22, and slots 48 formed in the cylindrical wall of the retainer post 22 on both sides of each protrusion 46 allow the protrusions 46 to bend radially inward as the knob 14 is slid over the post 22. In this way, each of the protrusions 46 resiliently presses against the inner periphery of the knob 14 to support the knob 14 for tilt-free rotation with respect to the retainer post 22.

The exterior periphery of the retainer post 22 also includes a distributed array of non-compliant axial ribs 50 that extend radially outward from the wall of the post 22, but do not ordinarily engage the inner periphery of the knob 14. In the illustrated embodiment, some of the ribs 50 provide a complementary axial recess 52 on the inner periphery of the hollow retainer post 22; the recesses 52 accept complementary axial ribs 53 formed on the exterior periphery of push-button actuator 18 to properly orient and rotationally lock the push-button actuator 18 with respect to the retainer 16. For purposes of this invention, however, the axial ribs 50 on the exterior periphery of the retainer post 22 provide a hard stop to limit radially inward bending of the protrusions 46 in the event that lateral force applied to the grip portion 28 of knob 14.

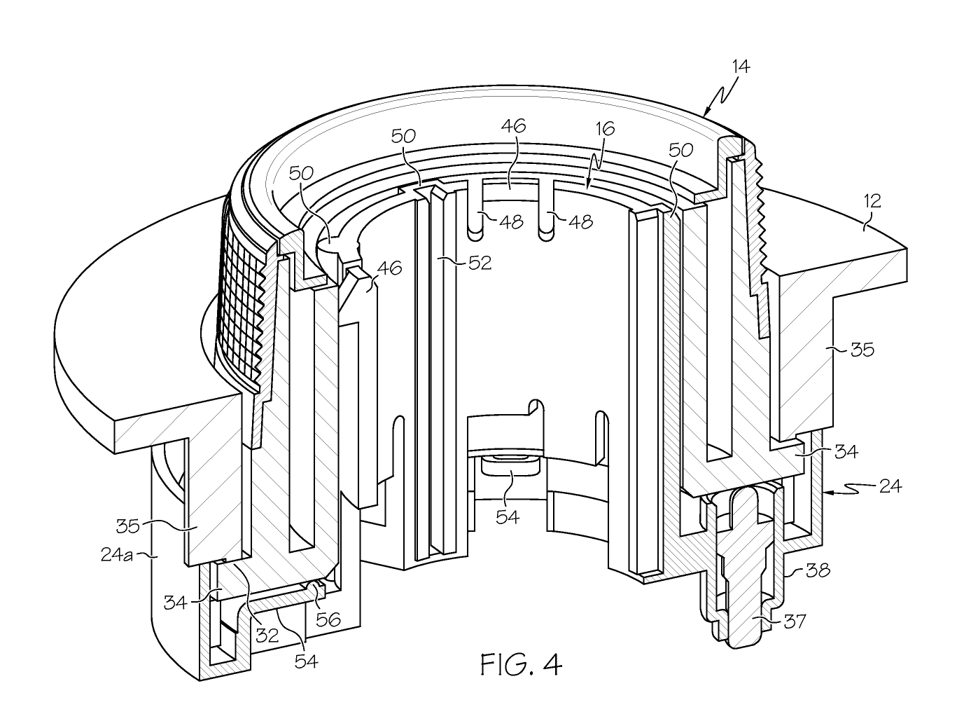

Referring to FIGS. 3-4, the cup-shaped retainer flange 24 is also provided with a distributed array of compliant tabs 54 that extend radially inward from the rim 24a of flange 24 to axially support the knob 14 when it is slid over the retainer post 22. A circular or domed boss 56 is formed on the upper surface of each tab 54 to minimize the area of contact with the knob 14, as the knob 14 rotates with respect to the tabs 54. And as seen in FIG. 4, the inwardly depending cylindrical flange 30 of trimplate 12 engages the ridges 32 on toothed flange 34 of knob 14 to capture knob 14 between trimplate 12 and the tabs 54 of retainer flange 24. Thus, knob 14 contacts the retainer 16 at the protrusions 46, the bosses 56 on tabs 54, and the ridges 32 on retainer flange 34; and a suitable lubricant is applied to these contacting surfaces to ensure smooth rotation of the knob 14.

In summary, the rotary control knob apparatus 10 of the present invention provides a simple and cost-effective way of mounting and rotatably supporting an annular rotary control knob 14 such that the axial orientation of the knob 14 is tightly controlled even though the retainer 16 on which the knob 14 is mounted is subject to customary manufacturing tolerance variations. The distributed array of compliant protrusions 46 on the exterior periphery of the hollow retainer post 22 provide a resilient sliding interference fit between the retainer post 22 and the inner periphery of knob 14 to achieve a highly reliable and substantially tilt-free rotational mounting of the knob 14. Additional mounting rigidity is achieved by locking and securing the retainer 16 to the trimplate 12.

While the present invention has been described with respect to the illustrated embodiment, it is recognized that numerous modifications and variations in addition to those mentioned herein will occur to those skilled in the art. For example, the push-button actuator 18 may be omitted, rotation of the knob 14 may be sensed in a different manner than shown, the retainer 16 may be directly fastened to the trimplate 12, and so on. Also, it may be possible to form the compliant features 46 on the inner periphery of the knob 14 instead of on the exterior periphery of retainer post 22. Accordingly, it is intended that the invention not be limited to the disclosed embodiment, but that it have the full scope permitted by the language of the following claims.

1. A rotary control knob apparatus comprising:
a knob retainer having a cylindrical post;
an annular knob fitted onto said cylindrical post; and
means including a radially and axially distributed array of compliant protrusions that establish a resilient interference fit between an exterior periphery of said cylindrical post and an interior periphery of said knob for rotationally supporting said knob on said cylindrical post while substantially preventing axial tilting of said knob with respect to said cylindrical post.

2. The rotary control knob apparatus of claim 1, where:
said compliant protrusions extend radially outward from the exterior periphery of said cylindrical post, and bend radially inward when said annular knob is fitted onto said cylindrical post.

3. The rotary control knob apparatus of claim 2, further comprising:
a distributed array of non-compliant axial ribs formed on the exterior periphery of said cylindrical post to limit the radially inward bending of said compliant protrusions when lateral force is applied to said knob.

4. The rotary control knob apparatus of claim 1, further comprising:
a trimplate having an opening through which a grip portion of said knob extends and an inwardly extending cylindrical flange that engages a flange of said knob to axially capture said knob between said trimplate and said knob retainer.

5. The rotary control knob apparatus of claim 4, further comprising:
a circuit board secured to said trimplate and axially capturing said knob retainer between said circuit board and said trimplate.

6. The rotary control knob apparatus of claim 1, where:
said knob retainer includes a flange extending radially outward from a base of said cylindrical post, and a distributed array of compliant tabs extending radially inward from a rim of said flange to axially support said knob.

7. The rotary control knob apparatus of claim 6, further comprising:
a trimplate having an opening through which a grip portion of said knob extends and an inwardly extending cylindrical flange that engages a flange of said knob to resiliently and axially capture said knob between said trimplate and said distributed array of compliant tabs.

8. The rotary control knob apparatus of claim 7, further comprising:
a set of ribs extending radially outward from the cylindrical flange of said trimplate, said ribs being received in slots formed in the rim of the flange of said of said knob retainer to rotationally lock said knob retainer to said trimplate.
